(19) United States
(12) Patent Application Publication
(10) Pub. No.: US 2014/0229488 A1
(43) Pub. Date: Aug. 14, 2014

(54) Apparatus, Method, and Computer Program Product For Ranking Data Objects

(71) Applicant: TELEFONAKTIEBOLAGET L M ERICSSON (PUBL), Stockholm (SE)

(72) Inventors: Tommy ARNGREN, Sodra Sunderbyn (SE); Tim Kornhammar, Lulea (SE)

(73) Assignee: Telefonaktiebolaget L M Ericsson (publ), Stockholm (SE)

(21) Appl. No.: 13/764,219

(22) Filed: Feb. 11, 2013

(51) Int. Cl. G06F 17/30

(52) U.S. Cl. CPC G06F 17/30864; G06F 17/30321
USPC 707/741; 707/748

(57) ABSTRACT

This disclosure relates to an apparatus, method and computer program product for ranking data objects. The method includes receiving an indication that a second user has performed an action included in a defined set of actions with respect to a data object uploaded by a first user. The method further includes: (a) calculating a rank for the first user; (b) calculating a rank for the second user; (c) calculating a crowd factor using the rank for the first user (R1) and the rank for the second user (R2), wherein the crowd factor is greater than or equal to R1+R2; and (d) determining a rank for the data object using the determined crowd factor, wherein these steps are performed in response to receiving the indication.

### TECHNICAL FIELD

This disclosure relates to apparatuses, methods and computer program products for ranking data objects (e.g., associating ranks with data objects).

### BACKGROUND

The number of data objects (e.g., HTML documents, video files, image files, audio files) that a user can access is growing larger and larger every day. Much of this growth is driven by technologies that have made it easy to capture and create audio/visual data (e.g., digital photographs, movies, presentations, audio files) and by social networking sites and file sharing sites that have made it easy to publish the data (e.g. upload the data to a publicly accessible server on the Internet). As technology becomes smarter and less expensive, the sharing of data objects will become even more common. Given this growth, researchers are working on ways to aid in the search and retrieval of relevant data objects.

One way to enable a user to search for and retrieve from a database relevant data objects stored in the database is to: (1) associate one or more tags (a.k.a., “keywords” or “labels”) with each of the data objects, (2) create an index comprising the tags, and (3) allow a user to formulate and submit to a search engine a search query containing one or more keywords, wherein the search engine is configured to search the index for tags that match the keywords and return to the user a list of the data objects paired with the matching tags. Such a system, however, may not be efficient if a large number of the data objects in the database are paired with the keywords entered by the searcher. One way to deal with this problem is to rank the data objects so that the list returned by the search engine lists the data objects in a rank order (e.g., highest ranked data object to lowest ranked data object).

What is desired, therefore, are systems and methods for ranking data objects.

### SUMMARY

This disclosure describes apparatuses, methods and computer program products for ranking data objects. Advantageously, in some embodiments, the ranks assigned to data objects are based on (a) the rank of the user who published the data object and (2) the ranks of other users who have performed an action with respect to the data object, such as tagging the data object, commenting on the data object, sharing the data object, playing the data object, liking the data object. Accordingly, in some embodiments, the rank of a data object can be influenced by the number of times users other than the user who published the data object acted on the data object.

In one aspect, the disclosure provides a method performed by a server apparatus for ranking a data object uploaded by a first user to the server apparatus. The method includes the server apparatus receiving from a second user's communication device a message comprising information indicating that a second user has performed an action included in a defined set of actions with respect to the data object. The following additional steps are performed in response to receiving the indication: (a) the server apparatus calculating a rank for the first user; (b) the server apparatus calculating a rank for the second user; (c) the server apparatus calculating a crowd factor using the rank for the first user (R1) and the rank for the second user (R2), wherein the crowd factor is greater than or equal to R1+R2; and (d) the server apparatus determining a rank for the data object using the determined crowd factor.

In some embodiments, the step of calculating the rank for the first user comprises: (a) obtaining (1) a user score (US1) associated with the first user, (2) a total action value (TAV1) associated with the first user, and (3) a an action number (N1) representing the number of times the first user has performed an action included in the defined set of actions with respect to any data object included in a particular set of data objects uploaded by the first user; and (b) using US1, TAV1, and N1 in calculating the rank for the first user. In some embodiments, the step of calculating the rank for the first user further comprises calculating: US1×(TAV1/N1).

In some embodiments, the step of calculating the rank for the first user further comprises updating TAV1 prior to using TAV1 in calculating the rank for the first user, and the step of updating TAV1 comprises increasing TAV1 by an amount associated with said action performed by the second user.

In some embodiments, the method further comprises updating US1 in response to the first user performing an action included in the defined set of actions, said performed action being associated with an action value. The step of updating US1 may comprises increasing US1 by said action value.

In some embodiments, the method further comprises determining a friend factor for the second user (FF2), and the step of calculating the crowd factor comprises using not only R1 and R3, but also using FF2; and in some embodiments, the crowd factor is greater than or equal to R1+R3+FF2.

In some embodiments, the method further comprises storing the determined rank for the data object in a record that includes a first field that stores a tag associated with the data object and a second field that stores a data object identifier that identifies the data object.

In some embodiments, the action performed by the second user is adding a tag to the data object. In such embodiments, the method may further include: (a) storing the tag in an index, (b) storing a data object identifier identifying the data object in the index such that the data object identifier is paired with the tag, and (c) storing the determined rank in the index such that the determined rank is paired with said data object identifier, which is paired with the tag.

In some embodiments, the action performed by the second user is liking a tag associated with the data object and the server apparatus has access to an index that stores the tag and a data object identifier that identifies the data object. Ins such embodiments, the method may further include storing the determined rank in the index such that the determined rank is paired with said data object identifier.

In another aspect, there is provided an apparatus for ranking a data object uploaded by a first user. In some embodiments, the apparatus includes a network interface for receiving a message comprising information indicating that a second user has performed an action included in a defined set of actions with respect to the data object. The apparatus may further include a non-transitory data storage medium; and a data processing system. The data storage medium stores program code for programming the data processing system such that, in response to the apparatus receiving the message, the data processing system performs a process comprising: (a) calculating a rank for the first user; (b) calculating a rank for the second user; (c) calculating a crowd factor using the rank for the first user (R1) and the rank for the second user (R2), wherein the crowd factor is greater than or equal to R1+R2; and (d) determining a rank for the data object using the determined crowd factor.

In another aspect, there is provided a computer program product comprising a non-transitory computer-readable medium storing computer program code for ranking a data object uploaded by a first user. The computer program code includes: (a) instructions for calculating a rank for the first user; (b) instructions for calculating a rank for a second user who performed an action on the data object; (c) instructions for calculating a crowd factor using the rank for the first user (R1) and the rank for the second user (R2), wherein the crowd factor is greater than or equal to R1+R2; and (d) instructions for determining a rank for the data object using the determined crowd factor.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments.

FIG. 1 illustrates a content sharing system according to some embodiments.

FIG. 2 illustrates an exemplary index according to some embodiments.

FIG. 3 illustrates the exemplary index after a user has tagged a data object.

FIG. 4 is a flow chart illustrating a process according to some embodiments.

FIG. 5 is a flow chart illustrating a process according to some embodiments.

FIG. 6 is a flow chart illustrating a process according to some embodiments.

FIG. 7 is a flow chart illustrating a process according to some embodiments.

FIGS. 8A-8B illustrate an example index.

FIGS. 9A-9B illustrate an example index.

FIG. 10 is a block diagram of a system according to some embodiments.

### DETAILED DESCRIPTION

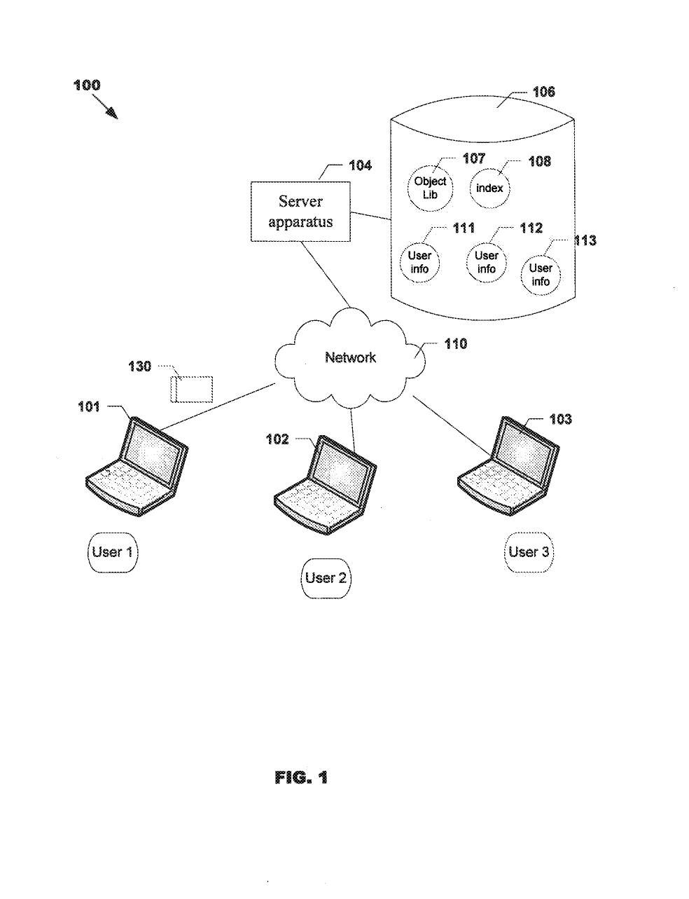

FIG. 1 illustrates a content sharing system (CSS) 100 according to some embodiments. CSS 100 enables users (e.g., user 1, user 2, user 3) to publish (e.g., share) data objects, which are typically stored in files. A data object includes: audio/video data (e.g., the contents of a movie file), a segment of a movie, an image (e.g., a digital photograph), audio data, text document, and other content. For example, user 1 may use a communication device 101 (e.g., mobile phone, computer, tablet device, etc.) to create a data object 130 (e.g., take a photograph and produce an image file containing image data) and upload (i.e., transmit) the data object 130 via a network 110 to a server apparatus 104.

Server apparatus 104 may include one or more physical machines (e.g., personal computers, server computers, blade servers, etc.), which machine may be co-located or distributed. Each such physical machine may execute a server program, such as a hypertext transfer protocol (HTTP) server program, which is commonly referred to as a “web server.” Additionally, each such physical machine may execute one or more virtual machines, and each virtual machine may execute a server program (e.g., a web server).

In embodiments where server apparatus 104 includes two or more machines (real and/or virtual), server apparatus 104 may include a load balancer to balance traffic among the machines. Data store 104 may include one or more data storage devices (e.g., disk drives, memory devices, etc.), which may be co-located or distributed. Network 110 may include the Internet.

In response to receiving data object 130 uploaded by user 1, server apparatus 104 may store the data object in a data store 106, thereby forming a collection (or “library”) of data objects 107. Data store 106 is in one embodiment comprised in the server apparatus 104, but may in other embodiments may be separate from the server apparatus 104, as is illustrated in FIG. 1.

In addition, server apparatus 104 may automatically analyze (e.g., parse) the data object 130 to create a set of one or more tags, include each of the tags in an index 108 (if not already included in the index), and associate data object 130 with each of the one or more tags, by, for example, associating a data object identifier that uniquely identifies data object 130 with each of the one or more tags. As used herein, a “tag” (noun) may be: a word, a phrase, a string of symbols, or set of symbol strings.

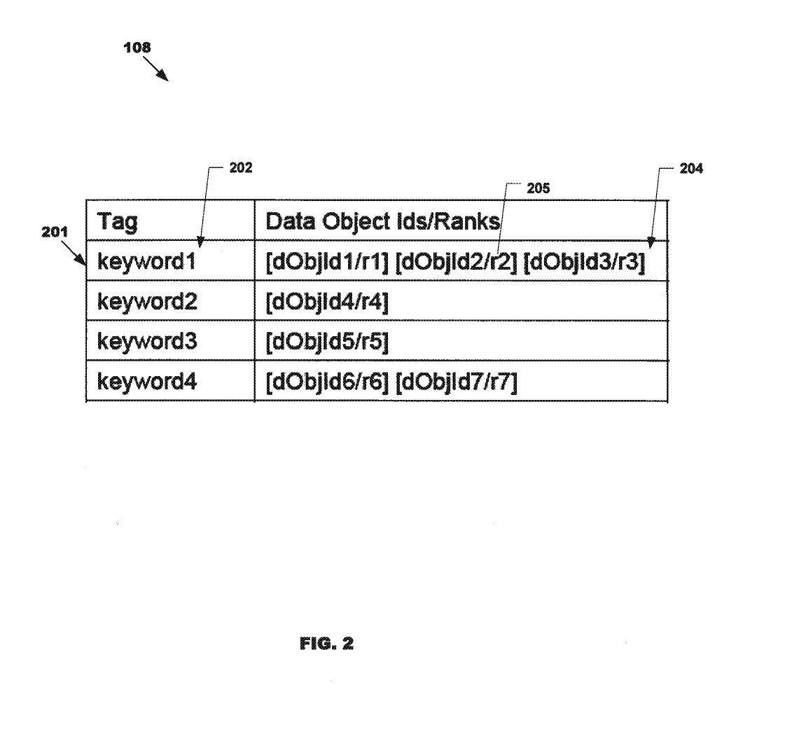

Server apparatus 104 may also calculate, for each of the one or more tags, a rank for the tag/data object 130 pair (i.e., a value indicating the rank of tag for data object 130), and store the rank in index 108 such that the rank is associated with the tag/data object 130 pair. This feature is illustrated in FIG. 2.

FIG. 2 illustrates an exemplary embodiment of index 108. As shown in FIG. 2, index 108 may contain a set of tags where each tag is associated with a set of one or more data object/rank pairs. For instance index 108 may include, for each tag, a database record 201 having a field 202 that stores the tag and a field 204 that stores a set of sub-fields 205, each sub-field 205 storing a data object identifier and a rank, wherein each data object identifier identifies a particular data object and the rank paired with the data object identifier identifies a previously determined rank for the data object identifier-tag pair.

For example, as illustrated in example index 108, the tag stored in filed 202 of record 201 (i.e., “keyword1”) is associated with three data object identifiers (dObjId1, dObjId2, and dObjId3) and three ranks (r1, r2, r3), where r1 is the rank of the tag with respect to dObjId1, r2 is the rank of the tag with respect to dObjId2, and r3 is the rank of the tag with respect to dObjId3. That is, for example, r1 is associated with the pair consisting of “Kewyord1” and “dObjId1”.

In addition to the server apparatus 104 automatically associating tags with the uploaded data object 130, user 1 may “tag” data object 130. For example, user 1 may input a tag into device 101 (e.g., by inputting a comment comprising a tag into a comment field of a web page or by inputting a tag into a tag field of the web page) and use device 101 to transmit to an HTTP server executed by a machine of server apparatus 104 a message (e.g., an HTTP message such as a GET, POST or PUT message) that contains the tag, an identifier that identifies data object 130, and information that causes server apparatus 104 to associate data object 130 with a tag included in the message. That is, for example, in response to receiving the message, server apparatus 104 includes a tag from the message in index 108 if the tag is not already included in index 108 and stores the data object identifier included in the message in the index such that the data object identifier is associated with the tag (e.g., the data object identifier may be stored in the record of index 108 that is used to store the tag). In addition, server apparatus 104 may calculate a rank for the tag/data object 130 pair and store the rank in index 108 such that the rank is associated with the tag/data object 130 pair, as described above. In embodiments where a user can tag a data object by inputting a comment and providing the comment to server apparatus 104, server apparatus 104 may be configure such that in response to receiving the comment from the user's communication device server apparatus parses the comment to extract one or more tags from the comment.

After user 1 uploads data object 130 to server apparatus 104, user 1 may also set the accessibility of data object 130 by sending to an HTTP server executed by a machine of server apparatus 104 a message (e.g., an HTTP message) including information indicating the user's preferred accessibility options. For example, the message may include information indicating that user 1 desires to allow anyone to access the data object. In another example, the message may indicate that user 1 desires that only users who are “friends” with user 1 may access the data object.

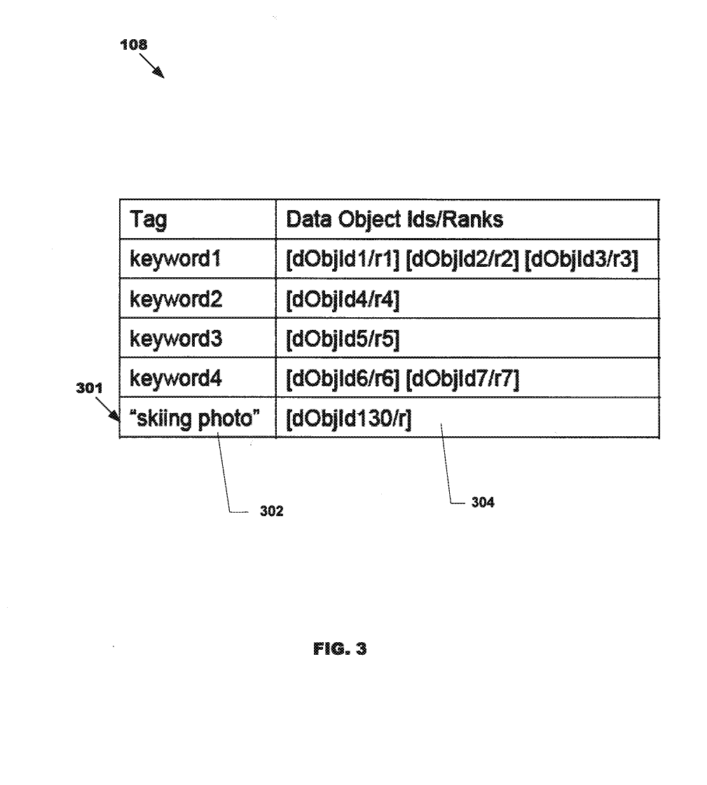

In some embodiments, the users who may access the data object may also “tag” the data object 130 in the same way that user 1 may tag the data object as described above. In such embodiments, in response to receiving the tag input by the user, server apparatus 104 includes the tag in index 108 (if the tag is not already included in index 108) and stores the data object identifier that identifies data object 130 (e.g. dObjId130) in the index such that the data object identifier is associated with the tag input by the user. As described above, server apparatus may also calculate a rank for the tag with respect to data object 130. For example, if the user tags data object 103 with the tag “skiing photo,” then server apparatus 104 may calculate a rank for tag “skiing photo” with respect to data object 130 and store in index 108 a new record 301 (see FIG. 3) that includes a field 302 that stores the tag “skiing photo” and a field 304 that includes a sub-field 305 that stores dObjId130 (i.e., the data object identifier that identifies data object 130) and a rank (r).

A user may also, in some embodiments, indicate whether the user likes or dislikes a tag or data object uploaded by another user. For example, the user may use a communication device to display a web page that includes: a data object, a first like button for enabling the user to indicate that the user likes the data object, a first dislike button for enabling the user to indicate that the user dislikes the data object, a tag associated with the data object, a second like button for enabling the user to indicate that the user likes the tag, and a second dislike button for enabling the user to indicate that the user dislikes the tag. In some embodiments, when the user activates one of the like/disklike buttons, the user's communication device sends to server apparatus 104 a message (e.g., HTTP message) indicating the button activated by the user, and server apparatus 104 responds to the message by, among other things, updating an appropriate rank. For instance, if the user activated the second like button, then server apparatus 104 will update the rank stored in index 108 that is associated with the tag and the data object. As used herein the term “button” encompasses not only icons that resemble a button, but also any clickable element (e.g., a hyperlink).

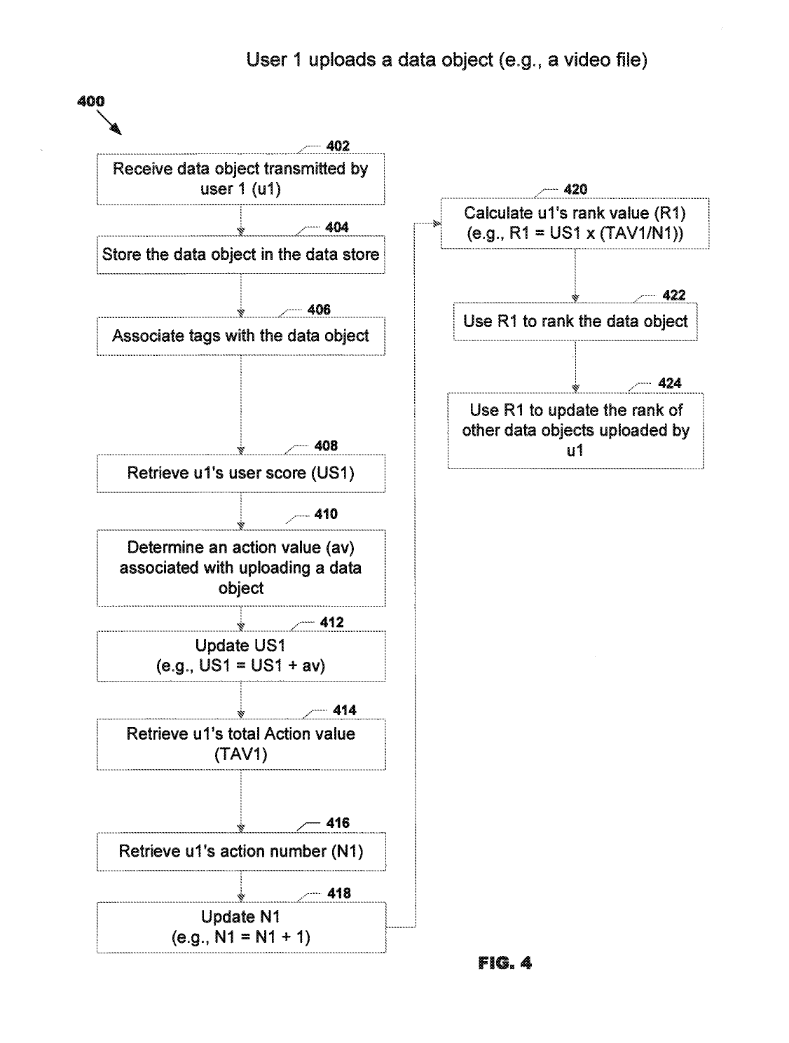

Referring now to FIG. 4, FIG. 4 is a flow chart illustrating a process 400, according to some embodiments, that may be performed by server apparatus 104 when user 1 uploads data object 130 to server apparatus 104 for inclusion in data object library 107.

Process 400 may begin with step 402, where server apparatus 104 receives data object 130.

In step 404, server apparatus 104 stores data object 130 in data store 106 and adds data object 130 to data object library 107.

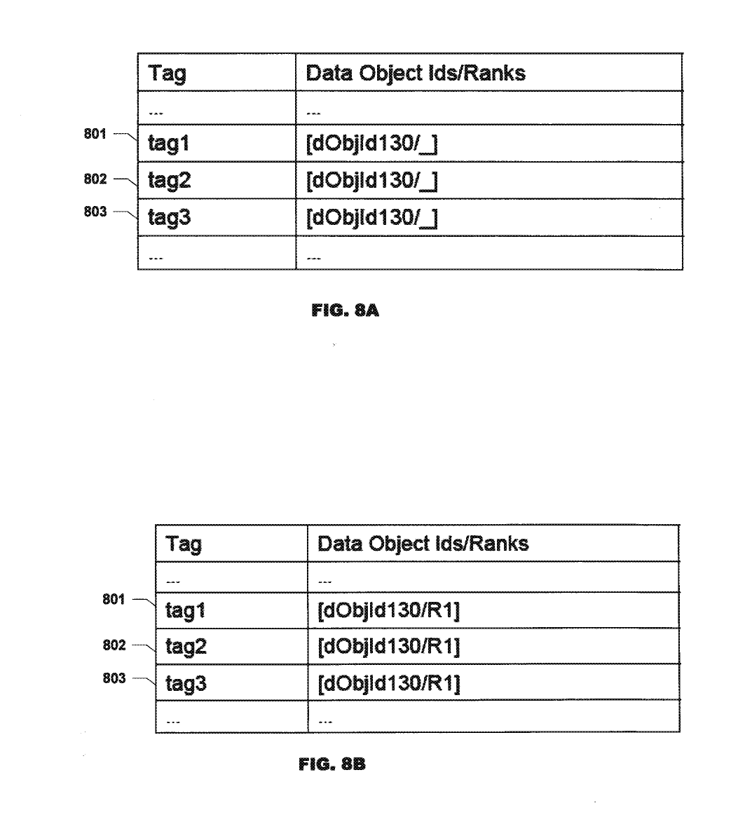

In step 406, server apparatus 104 associates a tag with data object 130. For example, as described above, server apparatus 104 may analyze data object 130 to create a set of tags and may store each of the tags in index 108 together with a data object identifier that identifies data object 130 (i.e., dObjId130). More specifically, for example, for each tag included in the set of stags, server apparatus 104 may create a new record in index 108, where each new record includes a first field that stores one of the tags and a second field that stores dObjId130. This is illustrated in FIG. 8A, which shows that server apparatus 104 created a set of three tags (tag1, tag2, tag3) and added three new records (801-803) to index 108, where each record includes a field that stores one of the tags and a field that stores dObjId130.

In step 408, server apparatus 104 retrieves from data store 106 user 1's user score (US1). Data store 106 may store, for each user that has registered with server apparatus 104, user information. The user information for each registered user may include, among other things, a user score (US), an action number (N), and a total action value (TAV) for that user.

In step 410, server apparatus 104 determines an action value (av) associated with the user action of uploading a data object to server apparatus 104. In some embodiments, a set of user actions is defined and an action value is defined for each of the user actions. For example, in some embodiments, the defined set of user actions includes: (1) uploading a data object; (2) adding a tag to a data object; (3) adding a comment on a data object; (4) liking a data object; (5) liking a tag; (6) liking a comment; (7) disliking a data object; (8) disliking a tag; (9) disliking a comment; (10) sharing a data object; and (11) playing a data object (e.g., playing a movie or segment of a movie), and each of these defined user actions has an associated action value. For instance, the user action of uploading a data object has an action value of 5, the user action of adding a tag has an action value of 2, the user action of liking/disliking a tag, comment or data object has an action value of 1.

In step 412, server apparatus 104 updates US1. For example, server apparatus 104 calculates US1=US1+av, where av is the action value determined in step 410. After US1 is updated, server apparatus 104 may replace the US1 stored in user 1's user information 111 with the updated US1.

In step 414, server apparatus 104 retrieves from data store 106 the total action value associated with user 1 (i.e., TAV1). For example, as mentioned above user 1's user information 111 may include a total action value (TAV). In some embodiments, a user's TAV is updated whenever some other user performs one the defined user actions with respect to a data object belonging to user 1. So, for example, if user 2 activates a like button associated with one of user 1's data objects, then user 1's total action value (TAV1) will be updated. For instance, in some embodiments, it will be increased by an amount equal to the action value associated with the action performed by user 2. Accordingly, if many other users act on user 1's data objects, then user 1 may have a relatively high total action value stored in user 1' user information 111.

In step 416, server apparatus 104 retrieves from data store 106 an action number associated with user 1 (N1).

In step 418, server apparatus 104 updates N1. In some embodiments, a user's action number is updated whenever the user takes an action with respect to a data object belonging to the user. So, for example, when user 1 adds a tag to one of user 1's data objects or uploads a new data object, server apparatus 104 updates user 1's action number (e.g., server apparatus 104 may calculate N1=N1+1). After N1 is updated, server apparatus 104 may replace the N1 stored in user 1's user information 111 with the updated N1.

In step 420, server apparatus 104 calculates a rank for user 1. For example, in some embodiments server apparatus 104 uses the following formula to calculate the rank: R1=US1×(TAV1/N1), where R1 is the calculated rank for user 1.

In step 422, server apparatus 104 uses R1 to set the rank of data object 130. For example, the rank of data object may be set equal to R1 or to some value calculated using R1. More specifically, in some embodiments, setting the rank of data object 130 to R1 comprises storing R1 in the rank information element portion of each sub-field of index 108 that stores the data object identifier that identifies data object 130. This is illustrated in FIG. 8B. As shown in FIG. 8B, in step 422, server apparatus may update each record 801, 802 and 803 by storing R1 in the record such that R1 is linked (e.g., paired) with dObjId130.

In step 424, server apparatus 104 may use R1 to set the rank paired with other data objects that user 1 previously added to library 107. These other data objects may be limited to other data objects that user 1 previously added to library 107 that no other user has yet acted on. For example, server apparatus 104 may update index 108 such that each data object identifier that identifies one of the other data objects is paired with a new rank is set to R1 or calculated using R1.

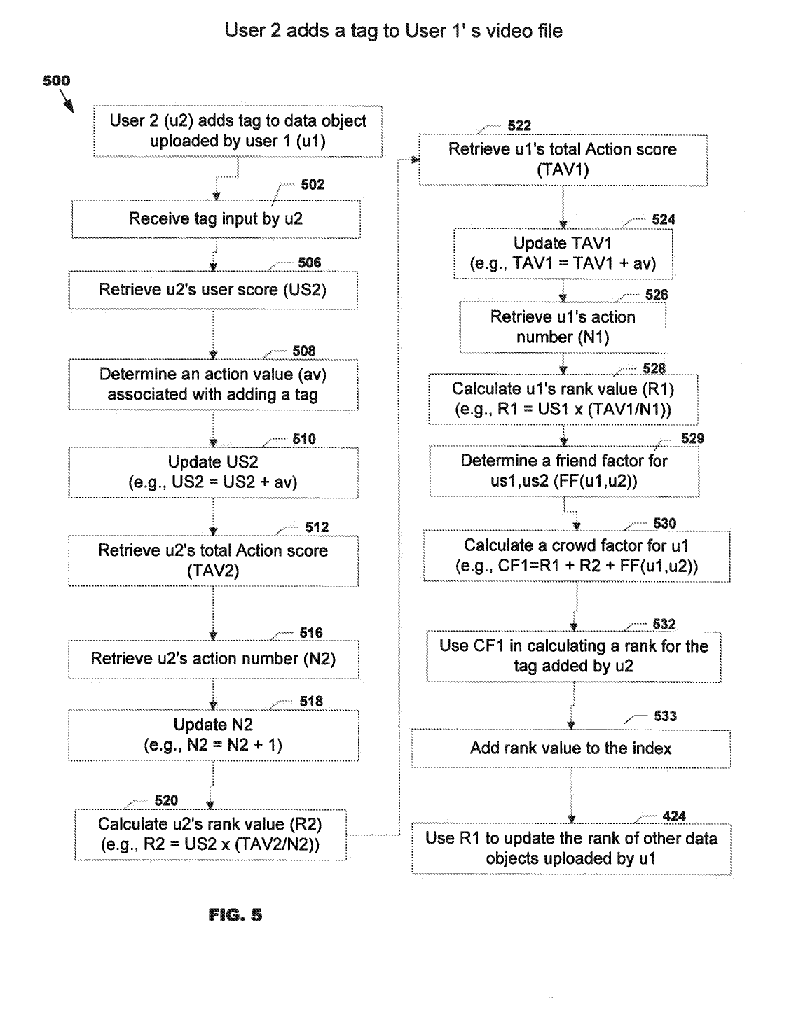

Referring now to FIG. 5, FIG. 5 is a flow chart illustrating a process 500, according to some embodiments, that may be performed by server apparatus 104 when user 2 (u2) adds a tag to data object 130, which was added to library 107 by user 1.

Process 500 may begin with step 502, where server apparatus 104 receives the tag input by user 2. For example, in some embodiments, user 2 adds a tag to data object 130 by inputting a tag into a form field displayed by communication device 102 and causing communication device 102 to transmit to server apparatus 104 a message (e.g., an HTTP message) comprising the tag input into the form field. Server apparatus 104 then receives the message, and, thereby receives the tag input by user 2.

In step 506, server apparatus 104 retrieves user 2's user score from user 2's user information 112 stored in data store 106.

In step 508, server apparatus 104 determines the action value associated with the user action of adding a tag to a data object.

In step 510, server apparatus 104 updates user 2's user score (US2) (e.g., calculates US2=US2+av, where av is the action value determined in step 508).

In step 512, server apparatus 104 retrieves user 2's total action value (TAV2) from user 2's user information 112 stored in data store 106.

In step 516, server apparatus 104 retrieves user 2's action number from user 2's user information 112 stored in data store 106.

In step 518, server apparatus 104 updates user 2's action number (e.g., calculates N2=N2+1, were N2 is user 2's action number that was retrieved in step 516).

In step 520, server apparatus 104 calculates a rank for user 2 using US2, N2 and TAV2 (e.g., calculate R2=US2×(TAV2/N2)).

In step 522, server apparatus 104 retrieves user 1's total action value (TAV1) from user 1's user information 111 stored in data store 106.

In step 524, server apparatus 104 updates TAV1 (e.g., calculates TAV1=TAV1+av, where av is the action value determined in step 508).

In step 526, server apparatus 104 retrieves user 1's action number (N1) from user 1's user information 111 stored in data store 106.

In step 528, server apparatus 104 calculates a rank for user 1 using US1, N1 and TAV1 (e.g., calculate R1=US1×(TAV1/N1)).

In step 529, server apparatus 104 determines user 1's friend factor for user 2, which we denote FF2. For example, server apparatus 104 first determines whether user 1 and user 2 are designated as “friends.” This information may be contained in user 1's and/or user 2's user information 112 stored in data store 106. If user 1 and user 2 are not friends, then server apparatus 104 may set FF2 equal to zero (e.g., FF2=0). If server apparatus 104 determines that user 1 and user 2 are friends, then server apparatus 104 retrieves from user 1's user information 111 a friend value associated with user 2 (fv2). The friend value associated with user 2 (fv2) may identify the number of times user 2 has performed an action on any one of user 1's data objects. Server apparatus 104 then uses the retrieved friend value (fv2) to calculate FF2. In some embodiments the formula used for calculating FF2 is: FF2=f(fv2)×R2, where f(fv2) is a value that depends on the value of fv2. In some embodiments, f(fv2) may simply equal fv2, whereas in other embodiments f(fv2) may equal c1 if fv2 is less than or equal to a threshold value and may equal c2 if fv2 is greater than the threshold, where c1 and c2 are predefined constants. Accordingly, user 1's friend factor for a particular user is value that depends on, at a minimum, whether user 1 and the particular user are designated as “friends.”

In step 530, server apparatus 104 calculates a crowd factor for user 1's data object 130 (CF1) using R1, R2, and FF (e.g., calculates CF1=R1+R2+FF2). Accordingly, the crowd factor, in some embodiments, is simply a calculated value that is calculated using user ranks and, optionally, friend factors. In some embodiments, a crowd factor (CF) for a particular user's data object (UserX's data object) is calculated according to the following equation: CF=RX+Rank-Sum+FF-Sum, where: RX is user X's rank value; Rank-Sum is the sum of the ranks associated with every other user that acted on UserX's data object; and FF-sum is the sum of the friend factors for each of those other users. As an example, assume that, prior to user 2 adding a tag to data object 130, the following other users acted on data object 130: user 3, user 4, user 5, . . . , and user N. In such a scenario, in some embodiments, server apparatus calculates CF1 as follows: CF1=R1+R2+R3+R4+R5+ . . . +RN+FF2+FF3+FF4+FF5+ . . . +FFN, where FF3=f(fv3)×R3, FF4=f(fv4)×R4, FF5=f(fv5)×R5, and FFN=f(fvN)×RN, and fv3, fv4, fv5 and fvN are friend values obtained from user information 111 and associated with users 3, 4, 5, . . . N, respectively. In other words, in this example, CF1=Sum(Ri, i=1, 2, 3, . . . , N)+Sum(FFi, i=2, 3, 4, . . . , N).

In step 532, server apparatus 104 uses CF1 to determine a rank (r) for the tag. For example, server apparatus 104 may set r=f(CF1), where f(CF1) is a value that depends on CF1. f(CF1) may simply be equal to CF1 or may be a value calculated using CF1.

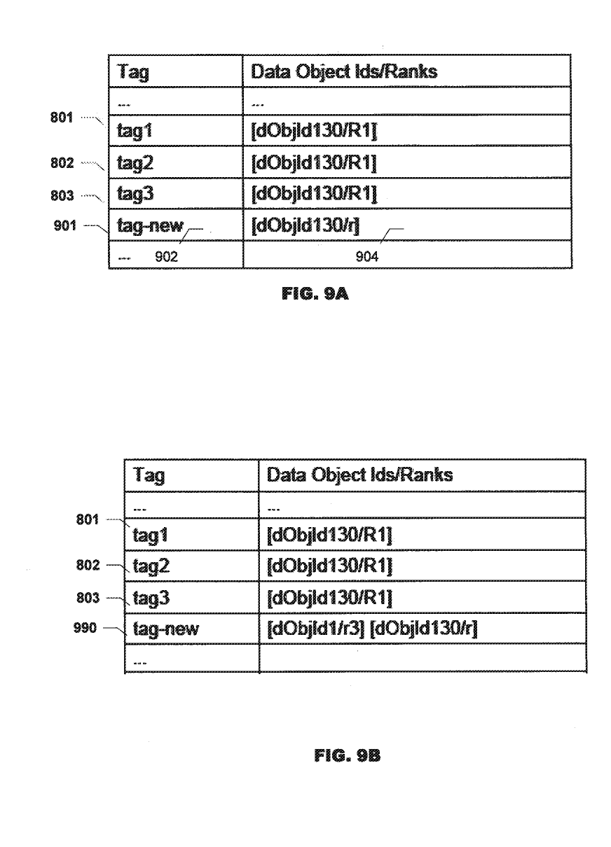

In step 533, after determining the rank for the tag, server apparatus 104 updates index 108. For example, if the added tag is not already included in index 108, server apparatus may add to index 108 a new record 901 (see FIG. 9A), which record 901 includes a field 902 that stores the new tag (tag-new) and a field 904 that stores the pair [dObjId130,r]. If the added tag is already included in index 108, then server apparatus may simply update the record 990 that stores the tag by adding a the pair [dObjId130,r] to that record, as shown in FIG. 9B.

After step 533, server apparatus may perform step 424.

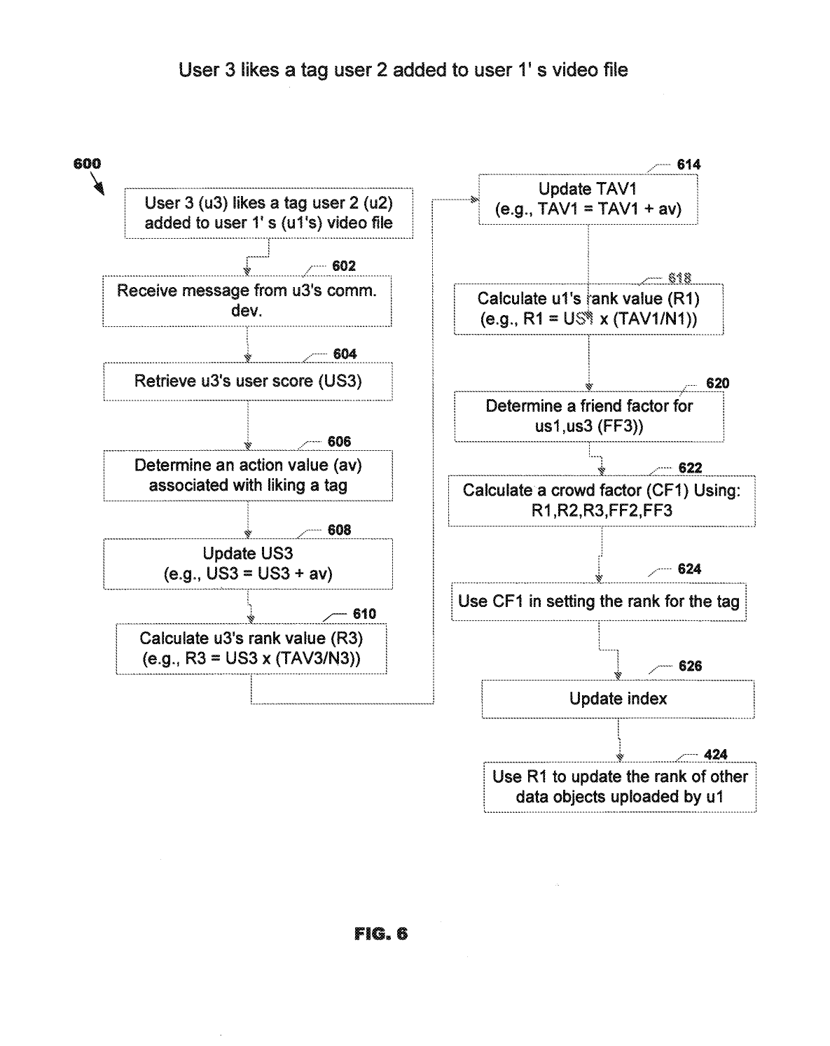

Referring now to FIG. 6, FIG. 6 is a flow chart illustrating a process 600, according to some embodiments, that may be performed by server apparatus 104 when user 3 (u3) likes a tag added by user 2 (u2) to data object 130 added to library 107 by user 1 (u1).

Process 600 may begin with step 602, where server apparatus 104 receives a message (e.g., HTTP message) transmitted by u3's communication device 103. The message includes a data object identifier identifying data object 130, the tag (or a tag identifier identifying the tag), and information indicating that u3 activated a like button associated with the tag.

In step 604, server apparatus 104 retrieves u3's user score (US3) from u3's user information 113 stored in data store 106.

In step 606, server apparatus 104 determines the action value associated with the user action of liking a tag.

In step 608, server apparatus 104 updates US3 (e.g., sets US3=US3+av, where av is the action value determined in step 606).

In step 610, server apparatus 104 calculates a rank for u3 (R3) using US3, TAV3, and N3, where TAV3 is a total action value included in u3's user information and N3 is an action number included in u3's user information (e.g., R3=US3×(TAV3/N3)).

In step 614, server apparatus 104 updates TAV1 (e.g., sets TAV1=TAV1+av, where av is the action value determined in step 606).

In step 618, server apparatus 104 sets R1 (rank for user 1) using US1, TAV1, and N1 (e.g., R1=US1×(TAV1/N1)).

In step 630, server apparatus 104 determine a friend factor (FF3) for us1,us3. For example, first determines whether user 1 and user 3 are friends. This information may be contained in user 1's and/or user 3's user information 113 stored in data store 106. If user 1 and user 3 are not friends, then server apparatus 104 may set the friend factor (FF) for user 1 and user 3 equal to zero (e.g., FF3=0). If server apparatus 104 determines that user 1 and user 3 are friends, then server apparatus 104 retrieves from user 1's user information 111 a friend value associated with user 3. The friend value may identify the number of times user 3 has performed an action on any one of user 1's data objects. Server apparatus 104 then uses the retrieved friend value (fv) to calculate the friend factor (FF3) (e.g., FF3=f(fv)×R3, where f(fv) is a value that depends on the value of fv).

In step 622, server apparatus 104 calculates a crowd factor for user 1 (CF1) using R1, R2, R3, FF2, and FF3, were FF2 is the friend factor determined in step 529 (e.g., calculates CF1=R1+R2+R3+FF2+FF3).

In step 624, server apparatus 104 uses CF1 to determine a rank (r) for the tag. For example, server apparatus 104 may set r=f(CF1), where f(CF1) is a value that depends on CF1. f(CF1) may simply be equal to CF1 or may be a value calculated using CF1.

In step 626, server apparatus 104 updates index 108. For example, server apparatus 104 updates index 108 to replace the rank associated the data object identifier stored in the record that stores the tag with the newly calculated rank.

After step 624, server apparatus may perform step 424.

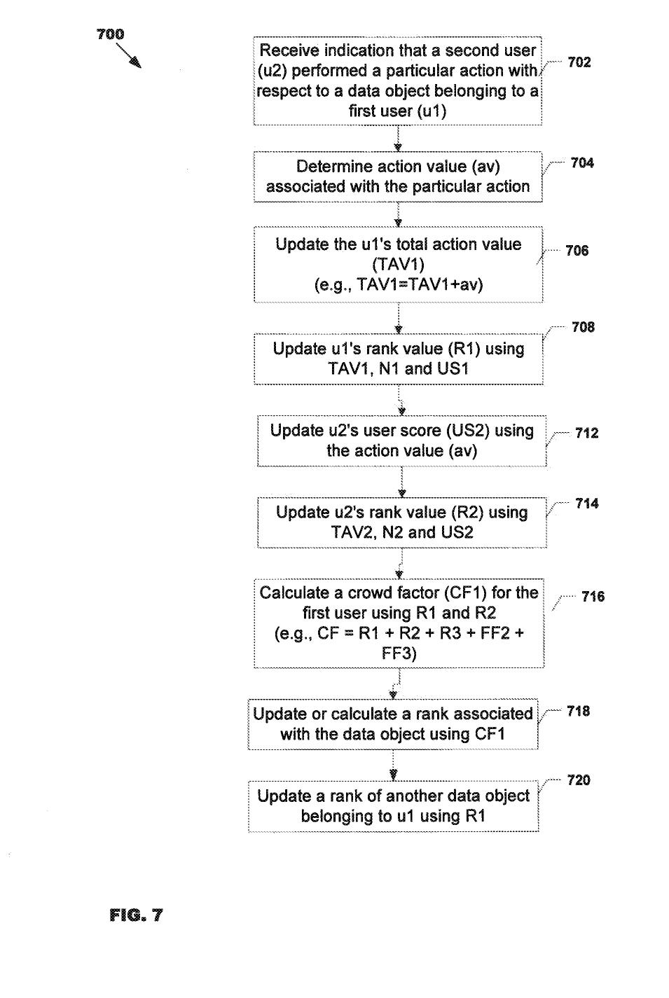

Referring now to FIG. 7, FIG. 7 is a flow chart illustrating a process 700, according to some embodiments, performed by server apparatus 104 in response to user 2 performing an action with respect to a data object belonging to user 1 (e.g. data object 130).

Process 700 may begin with step 702, where server apparatus 104 receives an indication that user 2 (u2) performed an action included in the defined set of user actions with respect to data object 130. For example, in step 702 server apparatus 104 may receive a message (e.g., an HTTP message) from user 2's communication device 102, wherein the message includes: a data object identifier identifying data object 130 and information identifying the action. The message may also include a tag or an identifier identifying a tag (e.g., an identifier identifying a comment that the user liked or disliked).

In step 704, server apparatus 104 determines an action value associated with the performed action.

In step 706, server apparatus 104 updates u1's total action value (TAV1) (e.g., sets TAV1=TAV1+av, where av is the action value determined in step 704).

In step 708, server apparatus 104 updates u1's rank (R1) using TAV1, N1, US1, where N1 and US1 are defined above (e.g., set R1=US1×(TAV1/N1)).

In step 712, server apparatus 104 updates u2's user score US2 using the action value (av) determined in step 704 (e.g. set US2=US2+av).

In step 714, server apparatus 104 update u2's rank (R2) using TAV2, N2, US2, where N2 and TAV2 are defined above (e.g., set R2=US2×(TAV2/N2)).

In step 716, server apparatus 104 calculates a crowd factor (CF1) for user 1 using R1 and R2. For example, as explained above, if user 2 liked a tag user 3 added to data object 130, the CF1 is calculated as follows: CF1=R1+R2+R3+FF2+FF3.

In step 718, server apparatus 104 calculates a rank using CF1 and stores the calculated rank such that the rank is associated with data object 130. For example, if user 2 added a tag to data object 130 or liked a tag previously added to data object 130, then server apparatus 104 updates the record that holds the tag such that the record will include the calculated rank.

In step 720, server apparatus 104 may set a rank associated with each other data object uploaded by user 1 using R1 determined in step 618. For example, the rank of each data object may be set to R1.

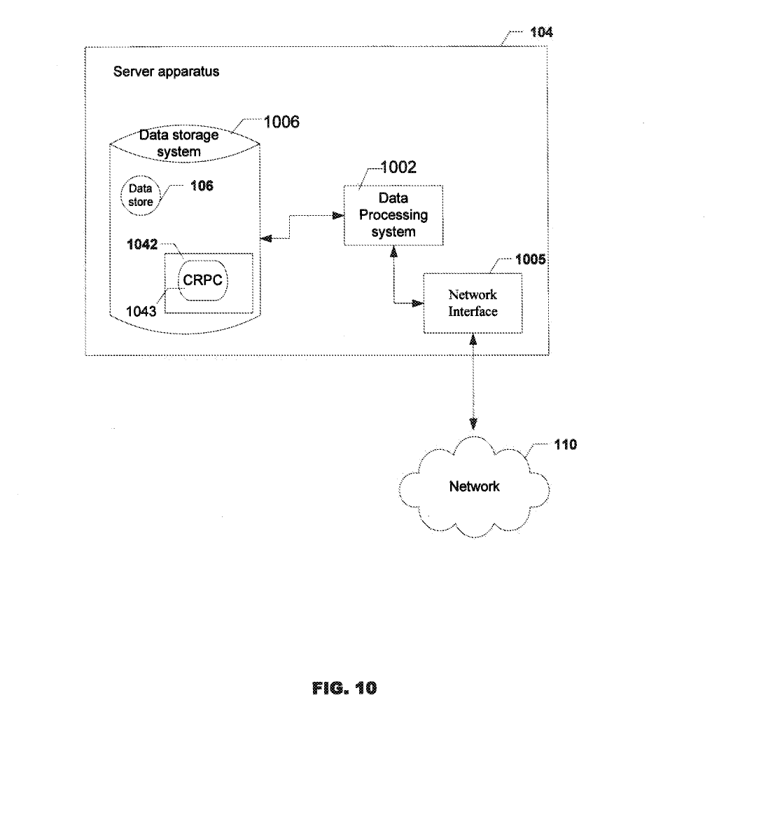

Referring now to FIG. 10, FIG. 10 illustrates a block diagram of server apparatus 104, according to some embodiments. As shown in FIG. 10, the server apparatus 104 may include: a data processing system 1002, which may include one or more data processing devices (e.g., a blade server, a server computer, etc.) each having one or more processors (e.g., a microprocessor) and/or one or more circuits, such as an application specific integrated circuit (ASIC), Field-programmable gate arrays (FPGAs), etc.; a network interface 1005 for receiving messages (e.g., HTTP Get or Post messages) from communication devices 101-103 and for transmitting messages (e.g. HTML documents) to devices 101-103; a data storage system 1006, which may include one or more computer-readable data storage mediums, such as non-transitory data storage apparatuses (e.g, hard drive, flash memory, optical disk, etc) and/or volatile storage apparatuses (e.g., random access memory (RAM)). As shown in FIG. 10, data store 106 may be a component of data storage system 1006.

In embodiments where data processing system 1002 includes a processor (e.g., a microprocessor), a computer program product is provided, which computer program product includes: computer readable program code 1043 (e.g., instructions), which implements a computer program, stored on a computer readable medium 1042 of data storage system 1006, such as, but not limited, to magnetic media (e.g., a hard disk), optical media (e.g., a DVD), memory devices (e.g., random access memory), etc. In some embodiments, computer readable program code 1043 is configured such that, when executed by data processing system 1002, code 1043 causes the processing system 1002 to perform steps described above (e.g., steps describe above with reference to the flow chart shown in FIGS. 4-6).

In other embodiments, server apparatus 104 may be configured to perform steps described above without the need for code 1043. For example, data processing system 1002 may consist merely of specialized hardware, such as one or more application-specific integrated circuits (ASICs). Hence, the features of the present disclosure described above may be implemented in hardware and/or software. For example, in some embodiments, the functional components of server apparatus 104 described above may be implemented by data processing system 1002 executing program code 1043, by data processing system 1002 operating independent of any computer program code 1043, or by any suitable combination of hardware and/or software.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for ranking a data object uploaded by a first user to a server apparatus, comprising:
the server apparatus receiving from second user's communication device a message comprising information indicating that the second user has performed an action included in a defined set of actions with respect to the data object; and
in response to receiving the indication:
the server apparatus calculating a rank for the first user;
the server apparatus calculating a rank for the second user;
the server apparatus calculating a crowd factor using the rank for the first user (R1) and the rank for the second user (R2), wherein the crowd factor is greater than or equal to R1+R2; and
the server apparatus determining a rank for the data object using the determined crowd factor.

2. The method of claim 1, wherein the step of calculating the rank for the first user comprises:
obtaining: (1) a user score (US1) associated with the first user, (2) a total action value (TAV1) associated with the first user, and (3) a an action number (N1) representing the number of times the first user has performed an action included in the defined set of actions with respect to any data object included in a particular set of data objects uploaded by the first user; and
using US1, TAV1, and N1 in calculating the rank for the first user.

3. The method of claim 2, wherein the step of calculating the rank for the first user further comprises calculating: US1×(TAV1/N1).

4. The method of claim 2, wherein
the step of calculating the rank for the first user further comprises updating TAV1 prior to using TAV1 in calculating the rank for the first user, and
the step of updating TAV1 comprises increasing TAV1 by an amount associated with said action performed by the second user.

5. The method of claim 2, wherein the method further comprises updating US1 in response to the first user performing an action included in the defined set of actions, said performed action being associated with an action value.

6. The method of claim 5, wherein the step of updating US1 comprises increasing US1 by said action value.

7. The method of claim 1, wherein
the method further comprises determining a friend factor for the second user (FF2);
the step of calculating the crowd factor comprises using not only R1 and R3, but also using FF2; and
the crowd factor is greater than or equal to R1+R3+FF2.

8. The method of claim 1, further comprising storing the determined rank for the data object in a record that includes a first field that stores a tag associated with the data object and a second field that stores a data object identifier that identifies the data object.

9. The method of claim 1, wherein
the action performed by the second user is adding a tag to the data object, and
the method further comprises:
storing the tag in an index,
storing a data object identifier identifying the data object in the index such that the data object identifier is paired with the tag, and
storing the determined rank in the index such that the determined rank is paired with said data object identifier, which is paired with the tag.

10. The method of claim 1, wherein
the action performed by the second user is liking a tag associated with the data object,
the server apparatus has access to an index that stores the tag and a data object identifier that identifies the data object, and
the method further comprises storing the determined rank in the index such that the determined rank is paired with said data object identifier.

11. An apparatus for ranking a data object uploaded by a first user, comprising:
a network interface for receiving a message comprising information indicating that a second user has performed an action included in a defined set of actions with respect to the data object;
a non-transitory data storage medium; and
a data processing system, wherein
the data storage medium stores program code for programming the data processing system such that, in response to the apparatus receiving the message, the data processing system performs a process comprising the steps of:
calculating a rank for the first user;
calculating a rank for the second user;
calculating a crowd factor using the rank for the first user (R1) and the rank for the second user (R2), wherein the crowd factor is greater than or equal to R1+R2; and
determining a rank for the data object using the determined crowd factor.

12. The apparatus of claim 11, wherein the step of calculating the rank for the first user comprises:
obtaining: (1) a user score (US1) associated with the first user, (2) a total action value (TAV1) associated with the first user, and (3) a an action number (N1) representing the number of times the first user has performed an action included in the defined set of actions with respect to any data object included in a particular set of data objects uploaded by the first user; and
using US1, TAV1, and N1 in calculating the rank for the first user.

13. The apparatus of claim 12, wherein
the step of calculating the rank for the first user further comprises updating TAV1 prior to using TAV1 in calculating the rank for the first user, and
the step of updating TAV1 comprises increasing TAV1 by an amount associated with said action performed by the second user.

14. The apparatus of claim 12, wherein
the data storage medium stores further program code for programming the data processing to update US1 in response to the apparatus receiving a message indicating that the first user performed an action included in the defined set of actions, and
the step of updating US1 comprises increasing US1 by an action value associated with the action performed by the first user.

15. The apparatus of claim 11, wherein
the data storage medium stores further program code for programming the data processing to determine a friend factor for the second user (FF2);
the step of calculating the crowd factor comprises using not only R1 and R3, but also using FF2; and
the crowd factor is greater than or equal to R1+R3+FF2.

16. The apparatus of claim 11, wherein
the data storage medium stores further program code for programming the data processing to stored the determined rank for the data object in a record that includes a first field that stores a tag associated with the data object and a second field that stores a data object identifier that identifies the data object.

17. A computer program product comprising a non-transitory computer-readable medium storing computer program code for ranking a data object uploaded by a first user, the computer program code comprising:
instructions for calculating a rank for the first user;
instructions for calculating a rank for a second user who performed an action on the data object;
instructions for calculating a crowd factor using the rank for the first user (R1) and the rank for the second user (R2), wherein the crowd factor is greater than or equal to R1+R2; and
instructions for determining a rank for the data object using the determined crowd factor.

18. The computer program product of claim 17, wherein the instructions for calculating the rank for the first user comprises:
instructions for obtaining: (1) a user score (US1) associated with the first user, (2) a total action value (TAV1) associated with the first user, and (3) a an action number (N1) representing the number of times the first user has performed an action included in the defined set of actions with respect to any data object included in a particular set of data objects uploaded by the first user; and
instructions for using US1, TAV1, and N1 in calculating the rank for the first user.

19. The computer program product of claim 18, wherein
the instructions for calculating the rank for the first user further instructions for updating TAV1, and
the instructions for updating TAV1 comprises instructions for increasing TAV1 by an amount associated with said action performed by the second user.

20. The method of claim 18, wherein
the program code further comprises instructions for updating US1 in response to the first user performing an action, said performed action being associated with an action value, and
the instructions for updating US1 comprises increasing US1 by the action value.
